(19) United States
(12) Patent Application Publication
(10) Pub. No.: US 2017/0302820 A1
(43) Pub. Date: Oct. 19, 2017

(54) Image Reading Apparatus, Image Reading Method and Image Forming Apparatus Therefor, That Ensure Guiding Reflected Light from Document Having High-Gloss Level to Light Receiving Portion

(71) Applicant: Kyocera Document Solutions Inc., Osaka (JP)

(72) Inventor: Toshiaki Mutsuo, Osaka (JP)

(21) Appl. No.: 15/490,989

(22) Filed: Apr. 19, 2017

(30) Foreign Application Priority Data
Apr. 19, 2016 (JP) 2016-083998

(51) Int. Cl. H04N 1/401; H04N 1/00; H04N 1/024; H04N 1/10; H04N 1/60

(52) U.S. Cl. CPC H04N 1/401; H04N 1/1061; H04N 1/6094; H04N 1/00806; H04N 1/0249; H04N 1/00819; H04N 2201/0081

(57) ABSTRACT

An image reading apparatus reads an image on a document surface. The image reading apparatus includes a document-supporting unit, a light source, and an image reading unit. The document-supporting unit supports the document and transmits light. The light source, from a direction inclined with respect to a line perpendicular to the document surface, irradiates the document surface with an irradiation beam transmitted through the document-supporting unit. The image reading unit reads the image in accordance with light reflected from the document surface and thereby generates image data. The document-supporting unit enables varying degree that the irradiation beam scatters in passing through the document-supporting unit.

### INCORPORATION BY REFERENCE

This application is based upon, and claims the benefit of priority from, corresponding Japanese Patent Application No. 2016-083998 filed in the Japan Patent Office on Apr. 19, 2016, the entire contents of which are incorporated herein by reference.

### BACKGROUND

Unless otherwise indicated herein, the description in this section is not prior art to the claims in this application and is not admitted to be prior art by inclusion in this section.

A typical image reading apparatus includes a light source that typically irradiates a document surface with a light at an angle of about 45 degrees with respect to the direction perpendicular to the document surface. This enables a light receiving portion to receive a diffusion light from an original document with a reduced regular-reflected light (specular-reflected light) from the original document. Light distribution of the reflected light, namely, a rate of the regular-reflected light included in the reflected light from the original document depends on a gloss level of the original document. Consequently, an original document with, for example, metallic luster causes almost all of the light distributions of the reflected light to become a regular reflection, thus causing a state where the light receiving portion cannot receive the reflected light from the original document (what is called a black-crush state). In response to such problem, there is disclosed a configuration that scans an original document in a direction inclined with respect to the original document and irradiates the original document with a light by changing an irradiation angle relative to the original document.

### SUMMARY

An image reading apparatus according to one aspect of the disclosure reads an image on a document surface. The image reading apparatus includes a document-supporting unit, a light source, and an image reading unit. The document-supporting unit supports the document and transmits light. The light source, from a direction inclined with respect to a line perpendicular to the document surface, irradiates the document surface with an irradiation beam transmitted through the document-supporting unit. The image reading unit reads the image in accordance with light reflected from the document surface and thereby generates image data. The document-supporting unit enables varying degree that the irradiation beam scatters in passing through the document-supporting unit.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a schematic configuration diagram of an overall configuration of an image forming apparatus according to one embodiment of the disclosure.

FIG. 2 illustrates a block diagram of an electrical configuration of the image forming apparatus according to the one embodiment.

FIG. 3 illustrates a cross-sectional view of the overall configuration of the image forming apparatus according to the one embodiment.

FIG. 4 illustrates contents of a calibration-process procedure of the image forming apparatus according to the one embodiment.

FIGS. 5A and 5B illustrate a reflection state of an original document in each light-transmission state of a contact glass according to the one embodiment.

FIG. 6 illustrates contents of a first calibration process in the image forming apparatus according to the one embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes a configuration for implementing the disclosure (hereinafter referred to as “embodiment”) with reference to the drawings.

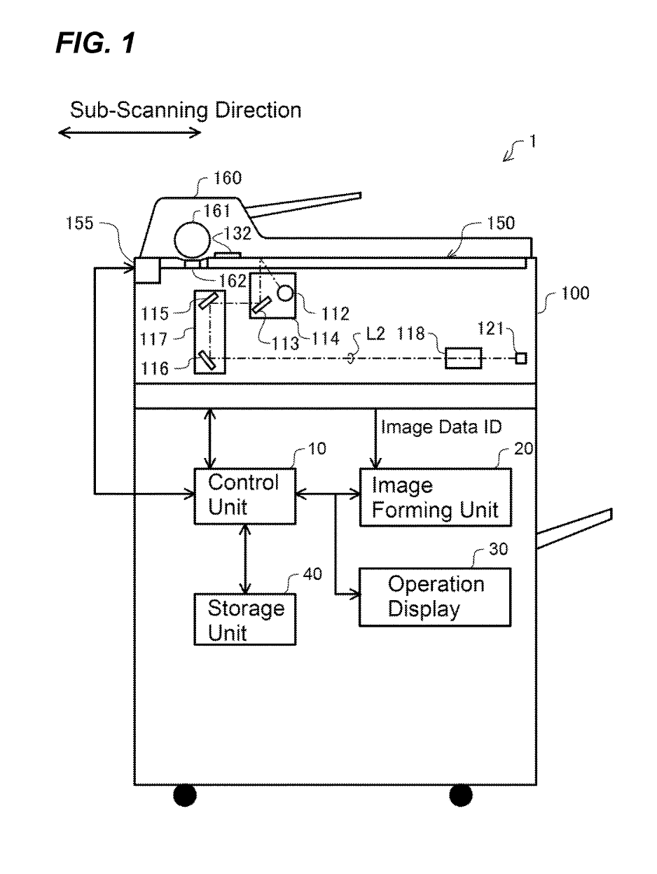

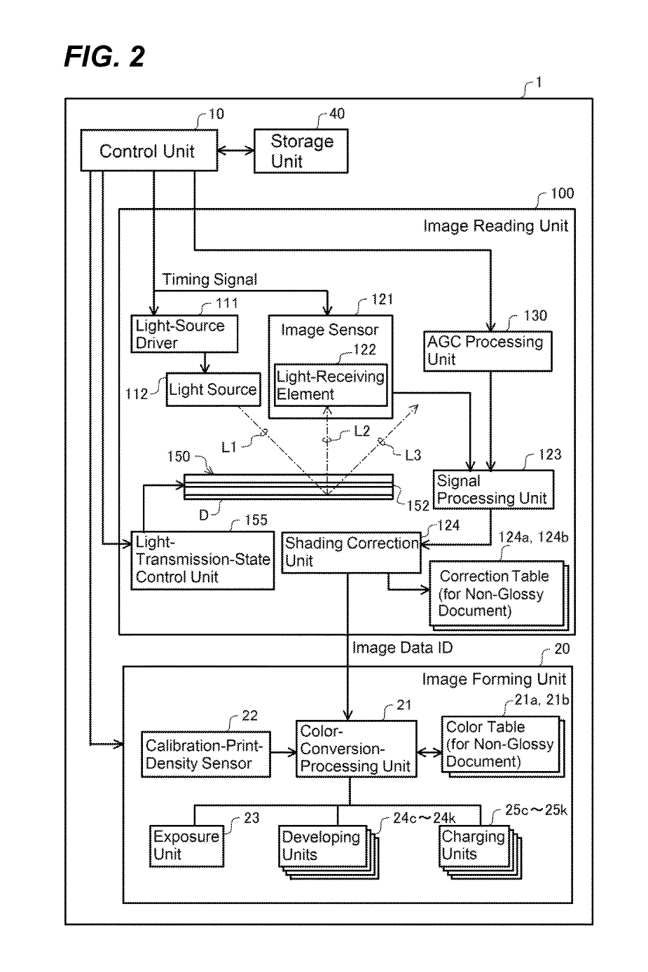

FIG. 1 illustrates a schematic configuration diagram of an overall configuration of an image forming apparatus 1 according to one embodiment of the disclosure. FIG. 2 illustrates an electrical configuration of the image forming apparatus 1 according to the one embodiment. The image forming apparatus 1 includes a control unit 10, an image forming unit 20, an operation display 30, a storage unit 40, and an image reading unit 100. The image reading unit 100 includes an automatic document feeder (ADF) 160 and a platen (contact glass) 150 and reads an image from a document to generate image data ID as digital data.

The image forming unit 20 forms an image on a print medium (not illustrated) based on the image data ID to discharge the print medium. The operation display 30 accepts an operation input of a user from a display (not illustrated) that functions as a touch panel, and various kinds of buttons and switches (not illustrated).

The control unit 10 includes: a main storage unit such as a RAM and a ROM; and a control unit such as a micro-processing unit (MPU) and a central processing unit (CPU). The control unit 10 has a controller function related to an interface such as various kinds of I/Os, a universal serial bus (USB), a bus, and other hardware, and controls the entire image forming apparatus 1.

The storage unit 40 is a storage device constituted of a hard disk drive, a flash memory, or similar memory, which are non-transitory recording media, and stores control programs and data for processes executed by the control unit 10.

The image reading unit 100, as illustrated in FIG. 2, includes a light-source driver 111 and a light source 112. The light source 112 includes a plurality of LEDs (not illustrated) that irradiate an original document D with a light. The light-source driver 111 is an LED driver that drives the plurality of LEDs arranged in a main-scanning direction, and performs an on and off drive control of the light source 112. This enables the light source 112 to irradiate the original document D with an irradiation light L1 by a pulse width modulation (PWM) with variable driving duty.

The original document D is irradiated with the irradiation light L1 at an angle of 45 degrees (inclined direction) with respect to the direction perpendicular to a surface of the original document D. The original document D reflects a reflected light including a diffuse-reflected light L2 and a regular-reflected light L3 (also referred to as specular-reflected light). A light receiving element 122 receives the diffuse-reflected light L2 via an optical path, which will be described later.

The image reading unit 100, as illustrated in FIG. 1, further includes a first reflecting mirror 113, a first carriage 114, a second reflecting mirror 115, a third reflecting mirror 116, a second carriage 117, and a condensing lens 118, between the original document D and an image sensor 121. The first reflecting mirror 113 reflects the diffuse-reflected light L2 from the original document D to a direction of the second reflecting mirror 115. The second reflecting mirror 115 reflects the diffuse-reflected light L2 to a direction of the third reflecting mirror 116. The third reflecting mirror 116 reflects the diffuse-reflected light L2 to a direction of the condensing lens 118. The condensing lens 118 forms an image of the diffuse-reflected light L2 on each light receiving surface (not illustrated) of a plurality of light receiving elements 122 included in the image sensor 121.

The image sensor 121 is a line sensor including the plurality of light receiving elements 122 arranged in the main-scanning direction. The plurality of light receiving elements 122 generate photoelectrically-converted electric charges in accordance with intensities of respective incident lights, and accumulate the electric charges in each potential well (a well of an electric charge) formed by a CCD element that corresponds to each pixel. The electric charges accumulated in each potential well are transferred to a shift register (not illustrated) all together. The respective electric charges transferred to the shift register are converted to an analog electrical signal as a voltage signal by an electric charge-voltage conversion amplifier. This enables the image sensor 121 to output an analog electrical signal for each of pixels in the main-scanning direction.

The first carriage 114 includes the light source 112 and the first reflecting mirror 113 and reciprocates in a sub-scanning direction. The second carriage 117 includes the second reflecting mirror 115 and the third reflecting mirror 116 and reciprocates in the sub-scanning direction. The first carriage 114 and the second carriage 117 are controlled by the control unit 10 that functions as a scanning control unit. This enables the light source 112 to scan an original document in the sub-scanning direction, thus enabling the image sensor 121 to output an analog electrical signal in accordance with a two-dimensional image on the original document.

When the ADF 160 is used, the first carriage 114 and the second carriage 117 are secured to a predetermined sub-scanning position, and scanning in the sub-scanning direction is performed by automatic feeding of the original document D. Some ADFs 160 read not only a single-side but also both sides simultaneously or sequentially.

The ADF 160 includes a paper feed roller 161 and a document reading slit 162. The paper feed roller 161 performs automatic feeding of an original document, and the original document is read via the document reading slit 162. In this case, the first carriage 114 is secured to the predetermined sub-scanning position, and thus the light source 112 included in the first carriage 114 is also secured to a predetermined position.

The image reading unit 100, as illustrated in FIG. 2, further includes a signal processing unit 123, a shading correction unit 124, an AGC processing unit 130, a white reference plate 132 (see FIG. 1), and a light-transmission-state control unit 155. The signal processing unit 123 is a variable gain amplifier having an A/D conversion function. The signal processing unit 123 amplifies the analog electrical signal using a gain, which is set by the AGC processing unit 130 and then stored in the storage unit 40, so as to convert the amplified-analog-electrical signal to digital data by an A/D conversion.

The light-transmission-state control unit 155 controls a light-transmission state of the contact glass 150. The light-transmission state includes a non-scattering state and a scattering state. The light-transmission-state control unit 155 is configured to adjust (is configured to vary) a degree of scattering continuously between the non-scattering state and the scattering state. In the non-scattering state, reading is performed by a diffuse reflection from a non-glossy document. In the scattering state, reading is performed by a regular reflection and a diffuse reflection from a glossy-document. The detail will be described later.

The AGC processing unit 130 is, in the embodiment, a gain adjustment unit that sets an appropriate gain and offset value for each of the plurality of light receiving elements 122 using a black reference signal and a white reference signal. The black reference signal is an analog electrical signal of the light receiving element 122 in a state where the light source 112 is turned off. The white reference signal is an analog electrical signal of the light receiving element 122 when the white reference plate 132 is irradiated instead of the original document D. The AGC processing unit 130 sets the offset value such that a value of the image data ID of the black reference signal A/D-converted by the signal processing unit 123 is the minimum value “0.” The AGC processing unit 130 sets the gain such that a value of the image data ID of the white reference signal A/D-converted by the signal processing unit 123 is the maximum value “255” using this offset value.

The shading correction unit 124 performs a shading correction on digital data to generate the image data ID. The shading correction is a correction for reducing light-amount non-uniformity in a longitudinal direction of the light source 112, peripheral dimming of a lens due to a cosine fourth-power law, and shading that occurs because of unevenness in sensitivity of the plurality of light receiving elements 122 arranged in the main-scanning direction.

According to an analysis of the present inventor, because scattering of the irradiation light L1 at a liquid-crystal film 152 changes an irradiation state of a light relative to the original document D (for example, occurrence of unevenness due to diffusion by the liquid-crystal film 152), in this embodiment, a shading-correction table 124b for a glossy-document mode is prepared separately from a shading-correction table 124a for a non-glossy-document mode (see FIG. 2).

For the shading correction, a shading-correction value is used. The shading-correction value is generated using the white reference plate 132 to be stored in the shading-correction table 124a for the non-glossy-document mode and the shading-correction table 124b for the glossy-document mode. The shading-correction table 124a for the non-glossy-document mode is adjusted such that the unevenness of the data in the main-scanning direction is reduced by use of the white reference plate 132 by setting the light-transmission state of the contact glass 150 to the non-scattering state. The shading-correction table 124b for the glossy-document mode is adjusted such that the unevenness of the data in the main-scanning direction is reduced by use of the white reference plate 132 by setting the light-transmission state of the contact glass 150 to the scattering state.

The image forming unit 20 forms, as described above, an image on a print medium P based on the image data ID and then discharges the print medium P.

The image forming unit 20 includes a color-conversion-processing unit 21, a calibration-print-density sensor 22, an exposure unit 23, developing units 24c to 24k, and charging units 25c to 25k. The color-conversion-processing unit 21 performs a color conversion on the image data ID as RGB data into CMYK, and performs halftone processing to generate CMYK halftone data. The color-conversion-processing unit 21 is configured to perform the color conversion using any one of a color table 21a for the glossy-document mode and a color table 21b for the non-glossy-document mode. The color table is also referred to as color conversion table.

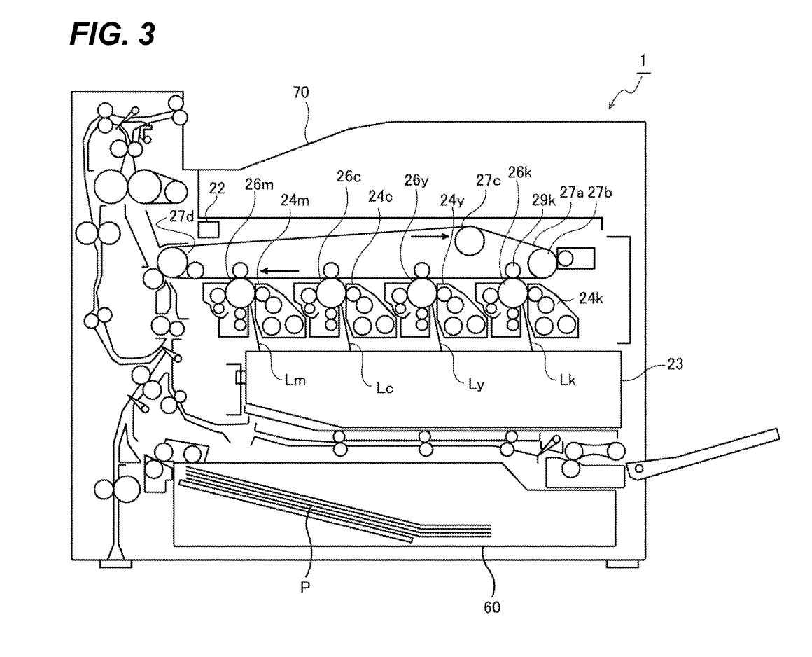

FIG. 3 illustrates a cross-sectional view of the overall configuration of the image forming apparatus 1 according to the one embodiment of the disclosure. The image forming apparatus 1 of the embodiment is a tandem type color printer. The image forming apparatus 1 includes a housing 70 inside which photoreceptor drums (image carriers) 26m, 26c, 26y, and 26k are arranged in one row corresponding to respective colors of magenta, cyan, yellow, and black. The developing units 24m, 24c, 24y, and 24k are arranged adjacent to the photoreceptor drums 26m, 26c, 26y, and 26k, respectively.

The exposure unit 23 irradiates the photoreceptor drums 26m, 26c, 26y, and 26k with laser beams Lm, Lc, Ly, and Lk for the respective colors. This irradiation forms electrostatic latent images on the photoreceptor drums 26m, 26c, 26y, and 26k. The developing units 24m, 24c, 24y, and 24k attach toners to the electrostatic latent images formed on the surfaces of the photoreceptor drums 26m, 26c, 26y, and 26k while stirring the toners. This completes the development process, thus ensuring the formed toner images of the respective colors on the surfaces of the photoreceptor drums 26m, 26c, 26y, and 26k.

The image forming apparatus 1 includes an endless intermediate transfer belt 27a. The intermediate transfer belt 27a is stretched by a tension roller 27c, a drive roller 27b, and a driven roller 27d. The intermediate transfer belt 27a is circularly driven by a rotation of the drive roller 27b.

For example, the photoreceptor drum 26k and a primary transfer roller 29k sandwich the intermediate transfer belt 27a, and then the intermediate transfer belt 27a is circularly driven. This causes a black toner image on the photoreceptor drum 26k to be primarily transferred onto the intermediate transfer belt 27a. The same applies to the other three colors of cyan, yellow, and black. The intermediate transfer belt 27a has the surface on which the primary transfers are performed and mutually superimposed at predetermined timings, and then a full-color toner image is formed. Then, the full-color toner image is secondarily transferred to the print medium P supplied from a sheet feed cassette 60, and is fixed on the print medium P by a well-known fixing process.

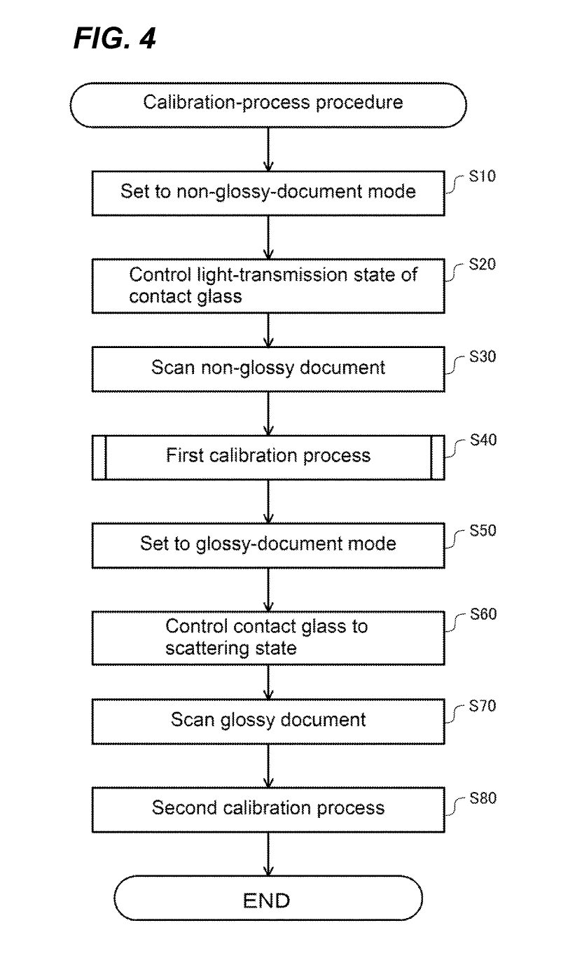

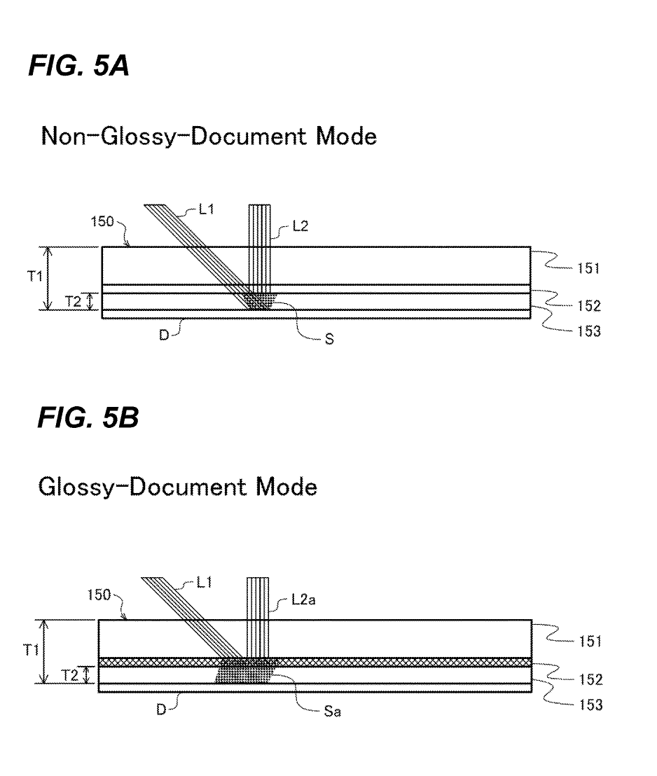

FIG. 4 illustrates contents of a calibration-process procedure of the image forming apparatus 1 according to the one embodiment. FIG. 5A to FIG. 5B illustrate reflection states from the original document in each light-transmission state of the contact glass 150 according to the one embodiment. At Step S10, a user sets a reading mode of the image forming apparatus 1 to the non-glossy-document mode. The setting of the non-glossy-document mode is performed by the user via the operation display 30. The image forming apparatus 1 has a plurality of operation modes including the non-glossy-document mode and the glossy-document mode.

At Step S20, the control unit 10 uses the light-transmission-state control unit 155 to control the light-transmission state of the contact glass 150 to the non-scattering state in response to the setting to the non-glossy-document mode. The light-transmission state includes the non-scattering state and the scattering state. The degree of scattering is continuously adjustable between the non-scattering state and the scattering state by the light-transmission-state control unit 155.

The contact glass 150 includes a base glass 151, the liquid-crystal film 152, and a front surface glass 153. The base glass 151 is a glass that is a foundation of the contact glass 150 and has sufficient strength. The front surface glass 153 is a glass that the original document D contacts directly and has sufficient hardness and strength.

The non-glossy-document mode enables the irradiation light L1 to transmit the contact glass 150 without scattering (non-scattering state), and the original document D is irradiated with the irradiation light L1 at an angle of 45 degrees with respect to a direction perpendicular to the surface of the original document D. The surface of the original document D diffusely reflects the irradiation light L1 to generate a diffuse-reflected light S, and part of the diffuse-reflected light S is radiated to a direction of the plurality of light receiving elements 122 as the diffuse-reflected light L2.

The liquid-crystal film 152 is constitutable by using, for example, a polymer dispersed liquid crystal. The polymer dispersed liquid crystal is a liquid crystal formed by a method utilizing a thin film (a liquid-crystal layer) where liquid crystals are dispersed in a polymer. The polymer dispersed liquid crystal causes the liquid crystals to exist without supporting (securing) the liquid crystals in the thin film by dispersing microparticles of the liquid crystals in the polymer like oil particles floating in water. Since orientation vectors of the dispersed liquid crystals are oriented in different directions, and a light is scattered at an interface surface when an electric field is not applied, the liquid-crystal film 152 generates a non-transparent white state. Application of an electric field by the light-transmission-state control unit 155 causes the liquid crystals to be oriented, thus causing the refractive index of the polymer and the liquid crystal to be approximately identical. This causes the liquid-crystal film 152 to become a transparent state (also referred to as a non-scattering state). Because the polymer dispersed liquid crystal requires neither a polarizer nor an orientation plate, ensuring the significantly reduced absorption of a light amount and ensuring driving with less electric power.

The document reading slit 162 of the ADF 160 may include a liquid-crystal film for generation of a scattering state. The contact glass 150 and the document reading slit 162 serve to support the surface of the original document D at a predetermined position in an optical system, and thus are also referred to as document-supporting unit.

At Step S30, the user uses the image reading unit 100 to scan a preliminarily-prepared-non-glossy document for calibration. The non-glossy document is a document that has a sufficiently low gloss level and causes most of the reflected lights to be diffuse-reflected lights. The non-glossy document for calibration is an adjustment document for CMYK calibration, and includes a plurality of patches indicative of respective tones of R for C calibration, a plurality of patches indicative of respective tones of G for M calibration, a plurality of patches indicative of respective tones of B for Y calibration, a plurality of patches indicative of respective tones of RGB (gray) for K calibration in one document.

At Step S40, the control unit 10 executes a first calibration process. The first calibration process is a process that calibrates the color table 21a for the non-glossy-document mode used for reading the non-glossy document.

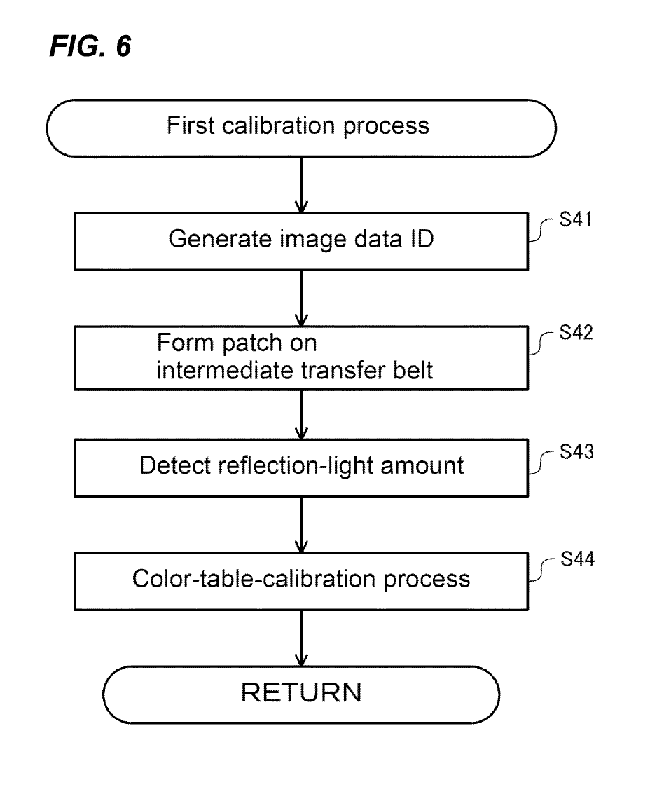

FIG. 6 illustrates contents of the first calibration process in the image forming apparatus 1 according to the one embodiment. At Step S41, the image reading unit 100 generates the image data ID based on the scan data of the non-glossy document for calibration. At Step S42, the image forming unit 20 forms a patch for calibration on the intermediate transfer belt 27a based on the image data ID. The patch for calibration is a patch formed by the image forming unit 20 based on the image data ID generated by scanning the non-glossy document for calibration.

At Step S43, the control unit 10 measures RGB-reflected-light amounts as reflected light amounts of RGB using the calibration-print-density sensor 22 to generate RGB-reflected-light-amount data. The RGB-reflected-light amounts correspond to the tone values of print image data RGB for calibration. Specifically, the RGB -reflected-light amounts correspond to light absorption levels (corresponding to a tone value of R) of a red light in patches of respective tones for a known cyan adjustment, light absorption levels (corresponding to a tone value of G) of a green light in patches of respective tones for a known magenta adjustment, light absorption levels (corresponding to a tone value of B) of a blue light in patches of respective tones for a known yellow adjustment, and light absorption levels (tone values of RGB) of RGB in patches of respective tones for a known gray adjustment.

At Step S44, the control unit 10 executes a color-table-calibration process. In the color-table-calibration process, the control unit 10 calibrates the color table 21 a for the non-glossy-document mode. The color table 21a is adjusted such that each light absorption level of the red light, the green light, and the blue light approaches a predetermined light absorption level. The predetermined light absorption level is prepared as a known value for the preliminarily-prepared-non-glossy document for calibration.

Thus, the image forming apparatus 1 is configured to calibrate the color table 21a for the non-glossy-document mode.

At Step S50, the user sets the reading mode of the image forming apparatus 1 to the glossy-document mode. The setting of the glossy-document mode is performed by the user via the operation display 30.

At Step S60, the control unit 10 uses the light-transmission-state control unit 155 to set the light-transmission state of the contact glass 150 to the scattering state (white state) in response to the setting to the glossy-document mode. The glossy-document mode causes the irradiation light L1 to transmit the base glass 151 and then to be scattered on the liquid-crystal film 152, so as to generate a scattered light. The scattered light transmits the front surface glass 153, and then the original document is irradiated with the scattered light in various directions. The original document D regularly and diffusely reflects the scattered light, with which the original document is irradiated in various directions, to generate a diffuse-reflected light Sa. The diffuse-reflected light Sa is rear-projected to the liquid-crystal film 152. Part of the diffuse-reflected light Sa, which has been rear projected, is emitted to the direction of the plurality of light receiving elements 122 as a diffuse-reflected light L2a.

Thus, the glossy-document mode causes the irradiation light to be scattered on the liquid-crystal film 152 to generate the scattered light and enables the plurality of light receiving elements 122 to detect the scattered light by the rear-projection of the scattered light, which is reflected regularly and diffusely on the surface of the original document D. This enables the plurality of light receiving elements 122 to detect the reflected light including the regular-reflected light from the original document D having a high-gloss level.

At Step S70, the user uses the image reading unit 100 to scan a preliminarily-prepared-glossy document for calibration. The glossy document is a document that has a sufficiently high gloss level and causes most of the reflected lights to be the regular-reflected light. The glossy document for calibration is identical to the non-glossy document for calibration except the gloss level. Because the plurality of light receiving elements 122 ensures receiving the reflected light including both the regular-reflected light and the diffuse-reflected light, reading of an image of the original document D having the high-gloss level is achievable with little influence of variation of the gloss levels.

At Step S80, the control unit 10 executes a second calibration process. The second calibration process is a process that calibrates the color table 21b for the glossy-document mode similar to the first calibration process.

The color table 21b is, similar to the first calibration process, calibrated such that each light absorption level of the red light, the green light, and the blue light approaches a predetermined light absorption level. The predetermined light absorption level is prepared as the known value (the value identical to the above-described value for the non-glossy-document mode) for the preliminarily-prepared-glossy document for calibration.

The control unit 10 simply enables generation of the calibrated color table 21b for the glossy-document mode based on the color table 21a for the non-glossy-document mode by adjusting saturation in an HSV color space and an HLS color space that include, for example, saturation as a component. This is because, according to the analysis and an experiment by the present inventor, saturation of the scan data of the glossy-document significantly is reduced relative to the scan data of the non-glossy document.

The reason of the significantly reduced saturation is that the plurality of light receiving elements 122 receive not only the diffuse-reflected light L2a as part of the diffuse-reflected light Sa, which has been rear projected to the liquid-crystal film 152, but also part of the diffuse-reflected light of the irradiation light L1, which has been front projected to the liquid-crystal film 152. The experiment of the present inventor where a tracing paper was used instead of the liquid-crystal film 152 confirmed a reduction of contrast due to a reduction of saturation (occurrence of dark color).

As described above, the image forming apparatus 1 according to the embodiment ensures guiding regular-reflected light from an original document having a high-gloss level to the image sensor 121, thus ensuring scanning of the original document having the high-gloss level. This principle is achieved by a combination of the scattering of the irradiation light near the original document and the rear projection of the reflected light from the original document. This optically complicated combination is achievable with a simple constitution of arranging the liquid-crystal film 152 to the contact glass 150 or the document reading slit 162.

The disclosure is not limited to the above-described embodiment and embodied as the following modifications.

Modification 1: While in the above-described embodiment the adjustment of the color table calibrates the contents of the color conversion process, the calibration may be performed by an adjustment of, for example, exposure energy, a charging bias, a developing bias, or a dot area rate.

Modification 2: While in the above-described embodiment the image reading unit employs a CCD method, the disclosure is not limited to the CCD method, and another method such as a CIS method may be employed.

Modification 3: The above-described embodiment may perform image processing that highlights a contour. This is because the analysis and the experiment of the present inventor found that the scan data of the glossy document has a tendency of blurring a contour relative to the scan data of the non-glossy document. The tendency of blurring the contour is caused by the light emitted to various directions when the diffuse-reflected light Sa is rear projected to the liquid-crystal film 152.

Because the blurring of the contour occurs when the diffuse-reflected light Sa is rear projected to the liquid-crystal film 152, reducing a thickness T2 (see FIG. 5B) of the front surface glass 153 ensures the reduced blurring of the contour. Therefore, it is preferable to reduce the thickness T2 of the front surface glass 153; in particular, it is preferable to reduce the thickness T2 to equal to or less than a half of a thickness T1 of the contact glass 150.

Modification 4: While in the above-described embodiment an adjustment of the scattering state of the liquid-crystal film is not performed, the embodiment may be configured to adjust the scattering state of the liquid-crystal film and may absorb, for example, individual difference of the image reading apparatus. As for an adjustment method, the adjustment may be performed by causing the scattering state to change to a direction where, for example, saturation and contrast become large.

Modification 5: While in the above-described embodiment the disclosure is applied to the image forming apparatus, the disclosure is also applicable to another image reading apparatus such as a dedicated scanner.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An image reading apparatus for reading an image on a document surface, the image reading apparatus comprising:
a document-supporting unit that supports the document and transmits light;
a light source that, from a direction inclined with respect to a line perpendicular to the document surface, irradiates the document surface with an irradiation beam transmitted through the document-supporting unit; and
an image reading unit that reads the image in accordance with light reflected from the document surface and thereby generates image data; wherein
the document-supporting unit enables varying degree that the irradiation beam scatters in passing through the document-supporting unit.

2. The image reading apparatus according to claim 1, wherein:
the image reading apparatus has a plurality of operation modes including a non-glossy-document mode and a glossy-document mode, the non-glossy-document mode being for reading an image on a non-glossy document as a document having a relatively small gloss level, the glossy-document mode being for reading an image on a glossy-document as a document having a relatively large gloss level;
the document-supporting unit relatively reduces the degree of scattering in the non-glossy-document mode and relatively increases the degree of scattering in the glossy-document mode; and
the image reading unit uses a color conversion table established for the non-glossy-document mode to generate the image data in the non-glossy-document mode, and uses a color conversion table established for the glossy-document mode to generate the image data in the glossy-document mode.

3. The image reading apparatus according to claim 1, wherein:
the image reading apparatus has a plurality of operation modes including a non-glossy-document mode and a glossy-document mode, the non-glossy-document mode being for reading an image on a non-glossy document as a document having a relatively small gloss level, the glossy-document mode being for reading an image on a glossy-document as a document having a relatively large gloss level;
the document-supporting unit relatively reduces the degree of scattering in the non-glossy-document mode, and relatively increases the degree of scattering in the glossy-document mode; and
the image reading unit uses a shading-correction table established for the non-glossy-document mode to generate the image data in the non-glossy-document mode, and uses a shading-correction table established for the glossy-document mode to generate the image data in the glossy-document mode.

4. The image reading apparatus according to claim 1, wherein:
the image reading apparatus has a plurality of operation modes including a non-glossy-document mode and a glossy-document mode, the non-glossy-document mode being for reading an image on a non-glossy document as a document having a relatively small gloss level, the glossy-document mode being for reading an image on a glossy-document as a document having a relatively large gloss level;
the document-supporting unit relatively reduces the degree of scattering in the non-glossy-document mode, and relatively increases the degree of scattering in the glossy-document mode; and
the image reading unit performs image processing to generate image data that in the glossy-document mode highlights contours more than in the non-glossy-document mode.

5. An image forming apparatus comprising:
the image reading apparatus according to claim 1; and
an image forming unit that forms an image based on the image data.

6. An image reading method that reads an image on a document surface, comprising:
preparing a document-supporting unit that supports the document and transmits light;
irradiating, from a direction inclined with respect to a line perpendicular to the document surface, the document surface with an irradiation beam transmitted through the document-supporting unit;
reading the image in accordance with light reflected from the document surface and thereby generates image data; and
varying degree that the irradiation beam scatters in passing through the document-supporting unit.
